(19) United States
(12) Patent Application Publication
(10) Pub. No.: US 2008/0317400 A1
(43) Pub. Date: Dec. 25, 2008

(54) Optical Element and Method for Controlling Its Transfer Function

(76) Inventor: Victor Petrov, St. Petersburg (RU)

Correspondence Address: CENTRAL COAST PATENT AGENCY, INC, 3 HANGAR WAY SUITE D, WATSONVILLE, CA, 95076, US

(21) Appl. No.: 12/067,283

(22) PCT Filed: Sep. 16, 2006
(86) PCT No.: PCT/EP2006/009043

§ 371 Date: Jul. 31, 2008

(30) Foreign Application Priority Data
Sep. 19, 2005 (DE) 10 2005 044 730.9

(51) Int. Cl. G02F 1/295

(52) U.S. Cl. 385/10

(57) ABSTRACT

Area: Optics

Optical element with Braggs phase grating that consists of electro-optical material or is embedded in an additional layer. The Braggs phase grating is designed as a series of periodically applied elevations and indentations of the waveguide's surface, coated with one layer of the compensating material and one layer of the electrically isolating material, along the propagation of light. The phase grating is equipped with a means of generating a spatially inhomogeneous, aperiodic, external electrical field.

Area of the Invention

The invention belongs to the physical area of optics and, in fact, to the optics methods and facilities for spectral filtering of optical radiation. This is based on electro-optical crystals and is to be used to produce narrow-band filters with a broad wave spectrum of changeover to wavelength, and for production of selective optical attenuators and modulators of light and optical equalisers.

Description of the Invention

The object of the invention is, on the one hand, the production of optical elements in an integral optical design that have a multifunctional use (tuneable optical filters, selective optical attenuators and modulators, optical switches and optical equalisers), and which possess a high spectral selectivity, a broad wavelength band of tuneability, great dynamics, and a low tendency toward cross-talk. A further aim of this invention was to develop a process for control of the aforementioned filters that makes it possible to electrically control the profile of the transfer function, the location of the transfer function's maximum, the number of channels to be selected, and compensation of phase distortion, while using a relatively low control voltage, and with a high tuneability and switching speed.

The task in hand is resolved by a large number of inventions that are related by one joint intention.

### FIELD OF THE INVENTION

The invention belongs to the physical area of optics and, in fact, to the optics methods and facilities for spectral filtering of optical radiation. This is based on electro-optical crystals and is used to produce narrow-band filters with a broad wave spectrum of changeover to wavelength, and for production of selective optical attenuators and modulators of light and optical equalisers.

### BACKGROUND OF THE INVENTION

The volume of information to be transmitted is currently growing disproportionately and is leading to the development of new technologies that make it possible to increase data transmission of the telecommunications networks One of the most future-oriented processes is condensing the signals in the channels of optical fibre-based data transmission networks (WDM—wavelength division multiplexing). In the near future, transmission of up to 80 spectral channels, with the generation of equidistant wavelengths from 1530 nm to 1600 nm, will make it possible to achieve transmission speeds of several terabits per second in optical networks.

It will only be possible to efficiently implement WDM in practice when a large number of optical elements such as splitters, routers, filters, modulators, amplifiers, etc. are available. For effective use of the new possibilities, it will also be necessary to achieve control and changeover of optical signals and their reshaping by electronic means. In this way, the role of controlled optical elements, for example the optical switch and the controllable optical filter, is growing increasingly. All known methods of spectral filtering of optical radiation are based on diffraction of radiation in Bragg phase gratings that have been fixed and written beforehand in a photo-reflective crystal [G. A. Rakuljic, V. Leyva—“Volume holographic narrow-band optical filter”.—Opt. Lett.—1993, Vol. 18, N 6 p.p. 459-461]. It is possible to use both the volume and also the wave guiding design of Braggs phase gratings [J. Hukriede, I. Nee, D. Kip, E. Kraetzig—“Thermally fixed reflection gratings for infrared light in LiNbO3:Ti:Fe Channel waveguides”.—Opt. Lett.—1998, Vol. 23, N 17, p.p. 1405-1407].

The actual spectral filtering takes place as follows. On illumination of the crystal by a light beam in the practically parallel direction to the direction of the vector of the phase grating, the light reflects only in the wavelength that corresponds to the Braggs condition in the phase grating, doing so in the opposite direction. The light of the remaining wave spectrum passes unchanged through the optically transparent crystal. To put it precisely, the light reflects on the phase grating in a specific narrow wave spectrum of the wavelength. The central wavelength of the light λ_{B} corresponds to the following formula:

λ_{B}=2nΛ (1)

### Where:

n—average refraction index of the crystal
Λ—period of the Braggs phase grating.
   The spectral selectivity of such a filter depends on the length of the Braggs phase grating and corresponds to the following formula:

$$\frac{d}{{λ}_{B}} = \frac{Λ}{T} wenn \frac{Λ}{T} >> \frac{{n}_{1}}{π n} \\ \frac{d}{{λ}_{B}} = \frac{{n}_{1}}{π n} wenn \frac{Λ}{T} >> \frac{{n}_{1}}{π n} \qquad ( 2 )$$

### Where:

d—waveband of the selective reflected light
n₁—amplitude of the change in the refraction index of the Braggs phase grating
T—length of the phase grating.

For modification of the chosen wavelength λ, an electric field with the field strength E can be applied transverse to the direction of the light's radiation propagation [R. Muller, J. V. Alvarez-Bravo, L. Arizmendi, J. M. Cabrera.—“Tuning of photorefractive interference filters in LiNbO3.—J. Phys. D. Apl. Phys.—1994, Vol 27, p.p. 1628-1632]. Due to the linear electro-optical effect (Pokkels effect), in the photorefractive crystals the average refraction index of the crystal n depends on the voltage of the electric field E as follows

$$Δ n = \frac{1}{2} {n}_{0}^{3} rE \qquad ( 3 )$$

### Where:

Δn—variation of the crystal's refraction index
n₀—average refraction index of the crystal, under the condition E=0
r—effective electro-optical coefficient, which depends on the direction of the electric field in relation to the crystallographic axes.

On modification of the electric field strength E, the filter is converted by virtue of the fact that a specific wavelength λ_{B} of the radiation to be filtered is chosen. The waveguide design enables generation of control fields at a relatively low applied voltage thanks to a very small distance between the electrodes (10 μm).

A holographic optical element is known [US005440669A] that performs the function of a narrow-band optical filter. This element consists of a photorefractive crystal in which the Braggs phase grating is written and fixed. The element has a very high spectral selectivity (it is possible to create the filter with a width of the spectral transfer function of at least 10 pm). The element can be used for light guidance with the entered degree of curvature and for simultaneous filtering of several wave fronts. When the known holographic element is used in fibre-optic networks, there is a need for volume design and additionally collimated optics. This, in turn, calls for precise adjustment. This is extremely cost-intensive and is thus not suitable for mass production.

A process of electrical changeover of a holographic optical filter in the photorefractive crystal [M. P. Petrov, V. M. Petrov, A. V. Chamrai, C. Denz, T. Tschudi.—“Electrically controlled holographic optical filter”.—Proc. 27th Eur. Conf. on Opt. Comm. (ECOC'01—Amsterdam).—Th.F.3.4, p.p. 628-629 (2001)] is known in which a spatially homogeneous field is created in the crystal by the application of a constant voltage to the crystal. On modification of the applied voltage and the related change in the electric field strength E, the filter is redesigned by virtue of the fact that a specific wavelength λ_{B} of the radiation to be filtered is chosen. The disadvantage of this process is the need to use very high control voltages, which are determined by small electro-optical coefficients of the photorefractive materials used. A further disadvantage is a small wave band of changeover to the amount of a maximum of 1 nm for LiNbO₃ limited by the electrical discharge.

A process of electrical multiplexing is known [M. P. Petrov, S. I. Stepanov, A. A. Kamshilin.—Light diffraction from the volume holograms in electrooptic birefringent crystals”.—Opt. Commun.—1979, No. 29, p.p. 44-48], which consists of writing a few Braggs phase gratings into one and the same volume of the photorefractive crystal at different values of the electric field strength. This process makes it possible to broaden the wavelength band of electrical redesign of the filter.

When this method is applied, however, there are limits to the number of switched spectral channels (which are determined by a maximum number of electrically multiplexed holograms) and the distance between adjoining channels. This limit arises due to extremely high demands on modern data transfer system with regard to cross-talk. Electrical switching gives rise to a simple shift of the central wavelengths of all gratings that are written into the crystal. The central wavelength band of a grating corresponds to the central wavelength band of the spectral channel that is currently activated. The remaining gratings simultaneously cause additional noise.

An electrical switch is known (WO 00/02098) that contains a paraelectrical photorefractive material in which at least one holographic grating is formed, with two electrodes that are applied onto the opposite edges of the material to apply an external electric field.

In the case of this switch, however, use is made of the crystal KLTN, in the paraelectrical phase, which acts close to the phase transition. This substantially increases the demands on stabilisation of the temperatures of this construction and limits the operating temperature range.

At the moment, no methods are known for the production of waveguides of a high quality using the crystal KLTN. This is why the constructions based on the known method of electro-holography can only be produced in the volume design and call for both high changeover voltages and complex optical tuning. This results in long changeover times.

The process of an optical switch (US004039249A) is also known. This process is based on a square electro-optical effect. This enables electrical activation of the holographic grating written into the paraelectrical grating. Activation is generated by the interaction of the spatially modulated distribution of the electric field that constitutes the holographic grating within the crystal and effect of the spatially homogeneous external electric field. This known process makes it possible to switch over the light, both in the direction of propagation and also depending on the wavelength. However, this known process requires high changeover voltages and complex optical tuning. This results in long changeover times.

The optical element described in [US005832148A] is the component that comes closes to the element to be registered in terms of a large number of its essential characteristics. It is based on a substrate on which a thin film of an electro-optical material has been applied that has a higher refraction index than that of the substrate itself. The film lying at the top is used as an optical waveguide. In an enhancement of this a specific electro-optical material (LiNbO₃) is used as the substrate and the optical waveguide is formed by the diffusion of an intermediate layer of titanium ions. Long-drawn electrodes are applied onto the surface of the electro-optical layer and a controlling voltage source is connected to them. The Braggs phase grating is written into the waveguide layer.

The filter has a very high spectral selectivity and performs the function of an electrically tuneable narrow-band optical filter (it is possible to create filters with spectral selectivity of less than 10 pm). The design of the waveguide makes it possible to create a large electric field strength with a relatively low voltage thanks to a very short distance between the electrodes (10 μm).

However, the wavelength band of tuneability of such a filter is limited by the voltage of electrical disruptive discharge and, in the case of the filter based on the crystal LiNbO₃ exceeds no more than 1 nm.

A further process for control of the transfer function of an optical filter is known, described as prototype [aaO], which applies an electric field to the electrodes that are applied to the layer surface of the electro-optical material. In the electro-optical material, the applied control voltage generates a homogeneous electric field strength that is oriented along the wave vector of the Braggs Phase grating. The formed electric field generates a change in the refraction index of the electro-optical material and thus a change in the light velocity within the waveguide. This leads to a change in the light intensity of the light reflected by the Braggs phase grating for a specific wavelength.

The wavelength of tuneability of such a filter is, however, limited by the voltage of the disruptive discharge and, in the case of the filter based on the crystal LiNbCO₃ exceeds no more than 1 nm.

### DESCRIPTION OF THE INVENTION

The object of the invention is, on the one hand, the production of optical elements in an integral optical design that have a multifunctional use (tuneable optical filters, selective optical attenuators and modulators, optical switches and optical equalisers), and which possess a high spectral selectivity, a broad wavelength band of tuneability, great dynamics, and a low tendency toward cross-talk. A further aim of this invention was to develop a process for control of the aforementioned elements that makes it possible to electrically control the profile of the transfer function, the location of the transfer function's maximum, the number of channels to be selected, and compensation of phase distortion, while using a relatively low control voltage, and with a high tuneability and switching speed. The task in hand is resolved by a large number of inventions that are related by one joint intention

Thus, the task in hand is resolved by virtue of the fact that the optical element is applied to an electro-optical material in which the Braggs phase grating is formed. The grating possesses a means of forming inhomogeneous, aperiodic, external electrical fields at least on parts of the length of the grating along the direction of propagation of optical radiation.

The Braggs phase grating can be formed in the optical waveguide of the electro-optical material in the form of the periodically applied elevations and impressions of the waveguide's surface in the direction of propagation of the light. The Braggs phase grating can be formed in the optical waveguide of the electro-optical material in the form of the periodically applied elevations and impressions of the waveguide's surface in the direction of propagation of the light. A layer of a material is additionally applied to the surface of the grating whose refraction index corresponds to the refraction index of the substrate, but which can deviate from the refraction index of the basis by a maximum of 40%.

The means for the formation of a spatially inhomogeneous, aperiodic, external electrical field can be created by the application of two electrodes that are located on both sides of the grating described above.

The means for the formation of a spatially inhomogeneous, aperiodic, external electrical field can be created by the application of two electrodes that are located on both sides of the grating described above. The distance between the two electrodes changes in linear fashion along the direction of radiation propagation.

The means for the formation of a spatially inhomogeneous, aperiodic, external electrical field can be created by four mutually isolated individual electrodes that are located in pairs on the two sides of the aforementioned grating.

The means for the formation of a spatially inhomogeneous, aperiodic, external electrical field can be created by four mutually isolated individual electrodes that are located in pairs on the two sides of the aforementioned grating. The distance between the respective electrode pair increases or decreases in linear fashion along the direction of radiation propagation.

The means for the formation of a spatially inhomogeneous, aperiodic, external electrical field can be created by applying at least three electrically mutually isolated electrodes that are located on both sides of the aforementioned grating and which are intended for control of the electrical field strength at various points of the aforementioned grating along the direction of the optical radiation. This construction can, for example, be realised in the quantity N of the aforementioned electrodes; the number of electrodes N is derived from the following formula:

N≧2D/d (4)

### Where:

D—wavelength band of electrical redesign of the filter

The task in hand can also be resolved by virtue of the fact that control of the profile of the filter's transfer function, which is based on an electro-optical material in which a Bragg's phase grating is formed which, in turn, possesses the means for creation of a spatially inhomogeneous, aperiodic, external electrical field at least on parts of the grating's length along the direction of propagation of optical radiation, takes place by means of the influence on at least part of the grating of a spatially inhomogeneous, aperiodic, external electrical field which causes the change in diffraction of the optical radiation, up to its maximum modification. Under the influence of a spatially inhomogeneous, aperiodic, external electrical field, the direction of the vector of the electrical field strength on a part of the aforementioned grating can be formed in the inverse direction to that of the vector of the electrical field strength on the other part of the grating.

The object of the invention is that the diffraction on the Braggs grating that is generated in the electro-optical material is controlled by the generation of an in homogeneous distribution of the electrical field within the material.

In the realisation of this control process, optical radiation can be introduced (coupled in) along the vector of the grating, with simultaneous recognition of the optical radiation reflected on the aforementioned grating due to the diffraction and the optical radiation routed through the optical crystal.

The control voltage can also be substantially reduced by use of the waveguide design by virtue of the fact that the light radiation to be filtered is distributed within the waveguide that is generated in the optical crystal and the speed of the transfer function is substantially increased.

The diffraction efficiency of the Braggs phase grating, consisting of the aperiodically applied elevations and indentations of the waveguide's surface in the direction of light propagation can be substantially improved. This is done by applying an additional layer of optical material onto the grating whose refraction index corresponds to the refraction index of the substrate, but which can deviate from the refraction index of the basis by a maximum of 40%.

The amount of the electrical disruptive discharge can also be substantially increased (enlarged) and consequently the amount of the tuneable wavelength band can be considerably increased. This is done by using an additional layer of an electrically isolatable material that fills the entire space between all electrodes, which substantially increases the voltage of the disruptive discharge, consequently making it possible to increase the voltage to be applied to the electrodes.

Just like in the known processes, diffraction of the radiation to be filtered is controlled by the formation of an electrical field of a specific strength in the crystal, as a result of which the refraction index of the crystal is changed. One special characteristic of the process pending registration is that the electrical field in the direction of radiation propagation is in homogeneous.

On creation of the necessary spatial distribution of the electrical field in the crystal, the required transfer function of the optical element can be created, which leads to the multifunctional nature of the optical element.

Thus, when the external electrical field modified homogeneously along the direction of radiation propagation is used, the diffraction efficiency of the grating can be substantially reduced, right down to zero. An electrical spectrally selective light switch can be created on this basis. Thanks to the electro-optical nature of the control, the switching speed of such a switch is very high and can amount to 10-100 GHz.

The diffraction efficiency of the Braggs phase grating can be controlled when the degree of inhomogeneity is altered. In this case, such an element functions as an electrically controlled selective light modulator.

The profile of the Braggs phase grating's transfer function can additionally be controlled electrically. Reconfiguration of the transfer function from the state of reflection to the state of forward conduction can server as an example. This reconfiguration is achieved by virtue of the fact that, on two identical halves of the grating, electrical fields are applied that generate a phase shift equal to π for the light waves reflected by both halves of the grating.

The optical element pending registration can act as a universal optical switch with a variable number of spectral channels. A specific number of the formed Braggs phase gratings is located in an inhomogeneous electrical field and therefore its diffraction does not exist. A homogeneous electrical field is applied to other phase gratings. This is why their diffraction exists. This circumstance enables reflection of the selected spectral channels.

The optical element to be registered can also act as an electrically controlled optical equaliser. In this case, the diffraction efficiency of each individual elementary grating is defined by the degree of the spatial inhomogeneity of the external electrical field.

The optical element to be registered can also act as a narrow-band optical filter with a broad wavelength band.

The optical element pending registration can also act as a compensator of optical spectral dispersion.

The following figures elucidate the object of the invention:

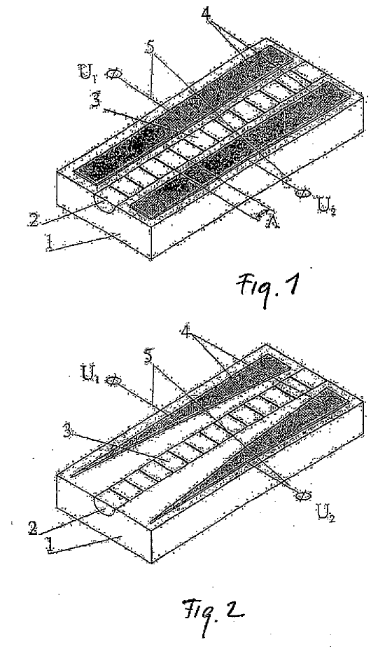

FIG. 1 shows the prototype of the optical element with two electrodes. (U₁ and U₂ represent the electrical voltages applied to the electrodes. Compensating and insulating material layers are not illustrated.)

In FIG. 2, the optical element is shown with two electrodes. The distance between the two electrodes decreases in linear fashion along the direction of radiation propagation.

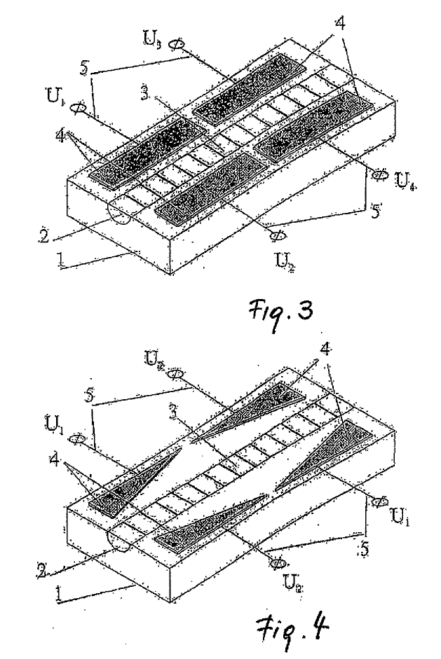

In FIG. 3, the optical element is shown with four electrodes.

In FIG. 4, the optical element is shown with four electrodes. The distance between the respective pair of the electrodes changes in linear fashion along the direction of radiation propagation.

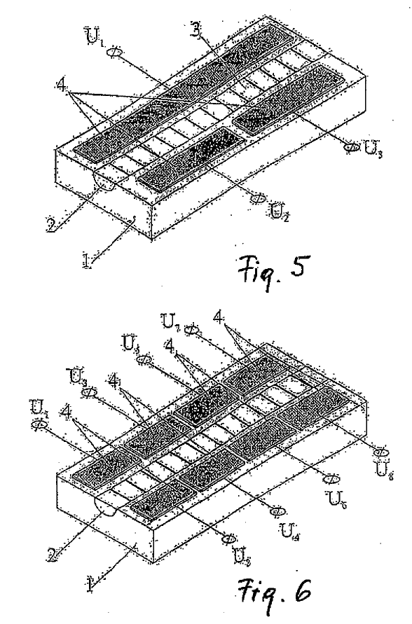

In FIG. 5, the optical element is shown with three electrodes.

In FIG. 6, the optical element is shown with eight electrodes.

In FIG. 7, the optical element is shown in a longitudinal section. The Braggs phase grating is designed as a series of periodically applied elevations and indentations of the waveguide's surface, coated with one layer of the compensating material and one layer of the electrically isolating material. (h—height of the waveguide. Δh—height difference between the indentations and the elevations.) The section runs along the waveguide (in the ABC plane).

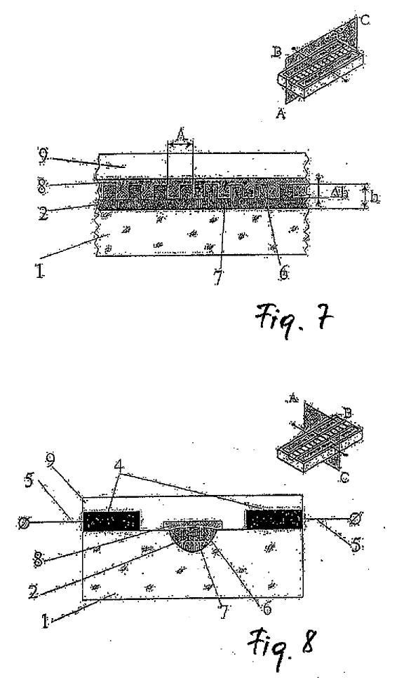

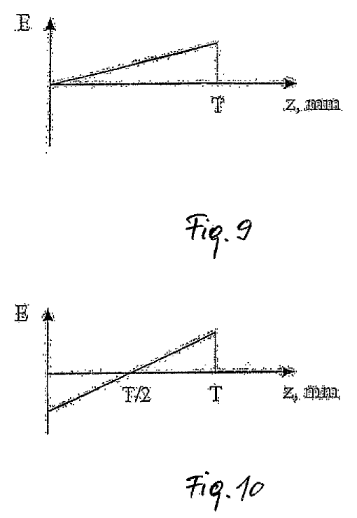

FIG. 8 shows the cross-section of the aforementioned optical element. The section runs transverse to the axis of the waveguide (in the DEF plane).

FIG. 9 shows the dependence of the electrical field strength E on the coordinates along the direction of radiation propagation for the arrangement of the electrodes on the element as shown in FIG. 2.

FIG. 10 shows the dependence of the electrical field strength E on the coordinates along the direction of radiation propagation for the arrangement of the electrodes on the element as shown in FIG. 4.

FIG. 11 shows the spectral characteristic of the Braggs phase grating's reflection coefficient. (λ—wavelength of the optical radiation, λ_{B}—central wavelength of the reflected optical radiation, d—width of the Braggs phase grating's transfer function).

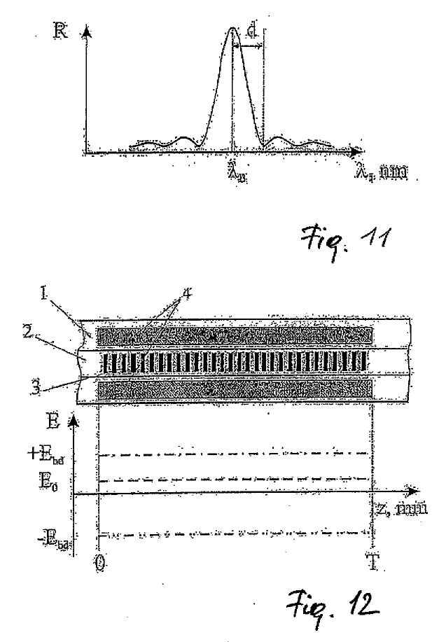

FIG. 12 shows the prototype of the optical element illustrated with a phase grating to which an external, homogeneous electrical field E is applied. (E_{bd}—electrical field strength at which the electrical disruptive discharge of the optical filter takes place, −E_{bd}—electrical field strength with reversive polarity, E₀—electrical field strength that serves to modify the central wavelength of the reflected radiation at the amount of the width of the Braggs phase grating's transfer function (d), T—length of the phase grating).

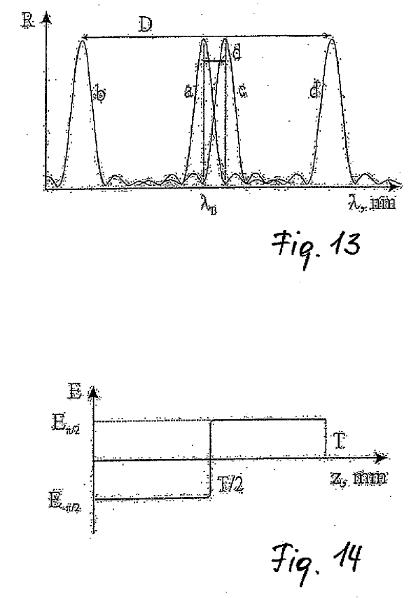

FIG. 13 shows the dependence of the optical element's spectral characteristic on the amount of the applied external electrical field strength (a—without electrical field, b—in the case of E=−E_{bd}, c−E=E₀, d—in the case of E=E_{bd}).

FIG. 14 shows one of the variants of the spatially inhomogeneous, external electrical field applied to the optical element. (E_{π/2}—electrical field strength on the first half of the grating that creates an additional phase difference of the optical radiation that is equal to π/2; −E_{π/2}—electrical field strength on the second half of the grating that creates an additional phase difference of the optical radiation that is equal to −π/2−).

FIG. 15 shows the transfer function of the element in the case in which the electrical field listed in FIG. 14 is applied to the element (continuous line—in the absence of the external electrical field; dashed line—in the presence of the external electrical field).

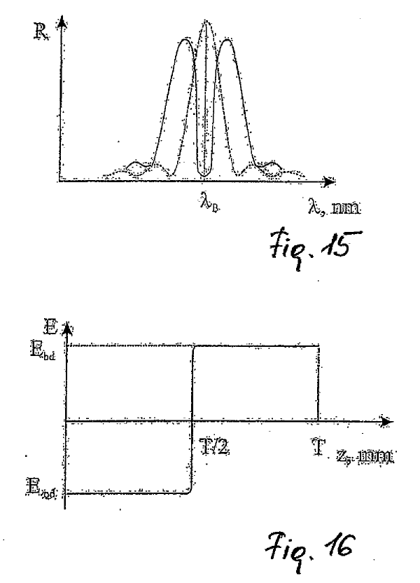

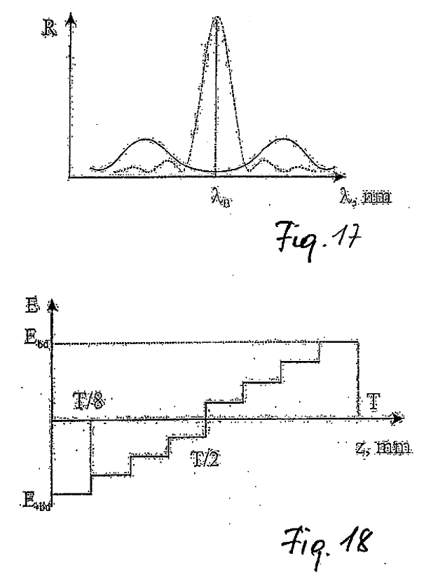

FIG. 16 shows a further possible variant of the spatially inhomogeneous, external electrical field applied to the optical element. (E_{bd}—electrical field strength on the first half of the grating, −E_{bd}—electrical field strength on the second half of the grating).

FIG. 17 shows the transfer function of the element in the case in which the electrical field listed in FIG. 16 is applied to the filter (continuous line—in the absence of the external electrical field; dashed line—presence of the external electrical field).

FIG. 18 shows a further possible variant of the spatially inhomogeneous, external electrical field applied to the optical element. (E_{bd}—electrical field strength on the first eighth of the grating at which the electrical disruptive discharge of the optical filter takes place, −E_{bd}—electrical field strength on the last eighth of the grating with reversive polarity).

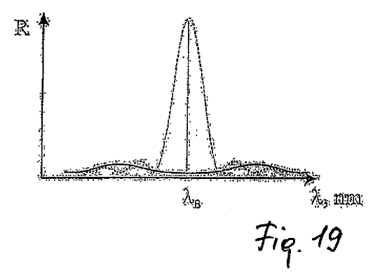

FIG. 19 shows the transfer function of the element in the case in which the electrical field listed in FIG. 18 is applied to the filter (continuous line—in the absence of the external electrical field; dashed line—presence of the external electrical field).

The optical element pending registration contains a pc board 1 made of electro-optical material in which the optical waveguide 2 can be formed (see FIG. 2). Crystals such as LiNbO₃, KNbO₃, BaTiO₃ or SBN can be used as electro-optical material. The Braggs phase grating 3 can be used both in the actual material of the pc board 1 and also in the optical waveguide 2. The grating 3 can be created both in the form of periodically applied elevations 6 and indentations 7 of the waveguide's surface in the direction of light propagation (see FIGS. 7, 8). Above the periodic elevations and indentations of the waveguide, a compensating layer of a material 8 is applied. This layer can consist of TiO₂ or SiO₂, for example.

On both sides of the grating 3, the means for creating spatially inhomogeneous aperiodic external electrical fields is located in the form of the electrodes 4, to which via contacts 5 electrical voltages U₁, U₂, U₃, . . . U_{N} are applied (depending on the number and configuration of the electrodes 4, the amplitude of the applied voltages can be identical or different and their polarity can be either different or identical).

The surface of the electrodes, the surface of the compensating material, the remaining surface of the basis and the remaining space between the electrodes is filled with the electrically insulating material 9. This material layer can consist of epoxy resin or any other plastic material that possesses a high coefficient of electrical resistance.

The spatially inhomogeneous aperiodic external electrical field can be created by electrodes 4 that have a different geometry. Thus, for example, by two electrodes whose distance from one another changes in linear fashion along the direction of radiation propagation (see FIG. 2); by three rectangular electrodes (see FIG. 5), which are influenced with different voltages U₁, U₂, U₃; by four electrodes of differing geometry (see FIGS. 3, 4); by eight rectangular electrodes (see FIG. 6), which are influenced with different voltages U₁, U₂, U₃, . . . U₈; by N electrodes with the following correspondence: N≧2D/d. The examples given above do not limit the choice of the number of electrodes and their configuration.

The transfer function of the optical element pending registration is controlled as follows. The necessary distribution of the electrical field strength's voltage is generated within the electro-optical material 1.

The necessary distribution of the electrical field strength's voltage can be created by a geometrical shape of the electrodes 4, which are influenced with the voltages U₁, U₂. FIG. 2 shows an example of the configuration of the electrodes for the generation of a spatially inhomogeneous aperiodic electrical field. The inhomogeneity of the electrical field is determined by the change in the distance between the electrodes. FIG. 9 shows the distribution of the electrical field strength for the configuration of the electrodes shown in FIG. 2. The maximum possible significance of the electrical field and of the related gradient is determined by the amount of the electrical disruptive discharge E_{bd}.

FIG. 4 shows the possibility of increasing the gradient of the electrical field strength by creating the system which, in turn, creates the inhomogeneous electrical field, in the form of two electrode pairs, with a changing distance between the electrodes. The voltages U₁, U₂ act on each electrode pair, each with inverse polarity. The distribution of the electrical field strength within the electro-optical material that corresponds to this configuration of the electrodes is shown in FIG. 10. The means for generation of a spatially in homogeneous, aperiodic electrical field in the form of N electrodes, which the voltage U influence via the contacts makes it possible to create different distributions of the electrical field strength within the electro-optical material and, what is particularly important, the nature of the dependence of the distribution of the electrical field strength can be modified by changing the amplitude of the applied voltages.

When the same voltage U₁ is applied to the electrodes on one side of the waveguide, and the same voltage U₂ is applied to the electrodes located on the other side of the waveguide, the spatially homogeneous electrical field is created in the electro-optical material (see FIG. 12). Such a field leads to shifting of the Braggs phase grating's transfer function (see FIG. 11) without changing the shape (see FIG. 13). The amount of the shift in the central wavelength is determined by the generated electrical field strength. The electrical field E₀ corresponds to the shift in the central wavelength along the width of the transfer function d (the curve c in FIG. 13). The polarity of the electrical field applied determines the direction of the shift in the central wavelength. The distance D between the central wavelengths of the transfer functions, which correspond to the applied homogeneous electrical fields, E_{bd} and −E_{bd}, is the entire wavelength range of tuneability of the central wavelength. Such a spatially homogeneous electrical field is generated in the prototype of the optical element (see FIG. 1). The simplest method of spatial distribution of an inhomogeneous electrical field is explained below. Here, the two halves of the grating are influenced with an identical electrical field in terms of amplitude, but with a differing electrical field in terms of polarity (see FIGS. 14, 16). Such a distribution of the electrical field strength can be generated by a system of the electrodes that is shown in FIG. 5 when U₁=0, U₂=−U₃. The Braggs phase grating is split into two gratings with shifted central wavelengths. In the event that the amount of the shift in the wavelengths is much greater than the width of the transfer function d, phase conditions can be ignored on addition of the light radiation reflected by the two halves of the grating. In this case, the optical element's transfer function converts to addition of the transfer functions of the two halves of the Braggs phase grating. The transfer function for this case is shown in FIG. 17.

The case in which, as a result of the difference in the electrical field strengths with which different halves of the grating are influenced, a difference in the phased of the reflected light radiation is generated that corresponds to π (see FIG. 14) is of considerable significance. In the case of the low amplitudes of the grating (n₁/n₀<<Λ/T) E_{π/2}=E₀, the central wavelengths differ merely by virtue of the width of the transfer function d. The amplitudes of the central wavelengths reflected by the different halves of the grating are coherently added, i.e. taking the phase into consideration. In this case, the local minimum is generated in the middle of the transfer function (see FIG. 15). In this case, the optical element allows central wavelengths to pass through instead of reflecting them. This example clearly points out the possibility of electro-optical control of the transfer function out of the “reflection” state into the “passage” state.

FIG. 18 shows the spatial distribution of the electrical field strength in the event that the Braggs phase grating is split into eight parts. Such a distribution of the field can be generated by a system of electrodes as is shown in FIG. 6. In this case, the following conditions are realised between the applied voltages: U₁=U₈, U₂=U₇, U₃=U₆, U₄=U₅. The light refracts on eight mutually independent parts of the grating with shifted central wavelengths. This leads to a reduction of the added reflection coefficient and to reduction of the spectral selectivity, i.e. to cancellation of the filter's transfer function (see FIG. 19).

The reduction in the length of the segment of the grating that are influenced with the homogeneous electrical field leads to a further reduction of the added reflection coefficient and to reduction of the spectral selectivity. In the event that the means for generation of the spatially inhomogeneous, aperiodic external electrical field consists of N electrodes, it is possible to generate an independent electrical field on N/2 of the parts of the grating (two electrodes each on both sides of the waveguide on each part of the grating).

The optimum number of electrodes is chosen from the ratio N≧2D/d, i.e. for effective cancellation of diffraction (reduction of the added reflection coefficient and for reduction of spectral selectivity), it is necessary to split the grating into N/2 independent parts. The number N is determined by the number of necessary selective channels.

It has been shown above how the nature of the optical element's transfer function can be modified with the aid of application of a spatially inhomogeneous, external electrical field. The example of cancellation of diffraction on the Braggs grating by reducing the added reflection coefficient and for reduction of the spectral selectivity was also shown. The process of control of the optical element's transfer function can be used in narrow-band optical filters, optical attenuators, optical modulators and in compensators of phase dispersion. The examples presented above do not, however, limit the possible fields of application of control of the transfer function.

### List of Identification References

1 pc board
2 Optical waveguide
3 Braggs phase grating
4 Electrodes
5 Contacts
6 Elevations
7 Indentations
8 Compensating layer of a material
9 Electrically isolating material

1. Optical element consisting of an electro-optical material and a Braggs grating that is formed in the electro-optical material,
characterised in that
the Braggs phase grating (3) has a means for generating spatially inhomogeneous, aperiodic, external electrical fields at least on parts of the length of the grating along the direction of propagation of optical radiation.

2. Optical element according to claim 1, characterised in that the Braggs phase grating (3) is formed in the optical waveguide (2) of the electro-optical material.

3. Optical element according to claim 2, characterised in that the Braggs phase grating (3) is formed as periodic elevations (6) and indentations (7) along the direction of propagation of light radiation of the optical waveguide (2).

4. Optical element according to claim 3,
characterised in that
the Braggs phase grating (3) possesses an additional layer consisting of compensating optical material (8) whose refraction index corresponds either to the refraction index of the substrate used or deviates from it by a maximum of 40%.

5. Optical element according to claim 4,
characterised
in that the means for forming a spatially inhomogeneous, aperiodic, external electrical field consists of two electrodes (4) on both sides of the Braggs phase grating (3).

6. Optical element according to claim 5, characterised
in that the means for forming a spatially inhomogeneous, aperiodic, external electrical field consists of two electrodes (4) on both sides of the grating (3), whereby the distance between the two electrodes (4) changes in linear fashion in the direction of radiation propagation.

7. Optical element according to claim 6, characterised in that the means for forming a spatially inhomogeneous, aperiodic, external electrical field consists of four electrically isolated electrodes (4) located in pairs on both sides of the grating (3).

8. Optical element according to claim 7, characterised in that the means for forming a spatially inhomogeneous, aperiodic, external electrical field consists of four electrically isolated electrodes (4) located in pairs on both sides of the grating (3), whereby the distance between the respective electrode pair changes in linear fashion along the direction of radiation propagation.

9. Optical element according to claim 8, characterised in that the means for forming a spatially inhomogeneous, aperiodic, external electrical field consists of at least three electrically isolated electrodes (4) located on both sides of the grating (3) and, for control of the electrical field strength, is realised at different points of the grating (3) along the direction of propagation of the light radiation.

10. Optical element according to claim 9, characterised in that the means for forming a spatially inhomogeneous, aperiodic, external electrical field consists of N of the electrodes (4), whereby the number of electrodes (4) corresponds to the formula N≧2D/d.

11. Optical element according to claim 10, characterised in that the means for generation of a spatially inhomogeneous, aperiodic, external electrical field possesses a layer of the electrically isolatable material (9) that fills the space between all electrodes (4). The material (9) serves to amplify the voltage applied to the electrodes (4).

12. Process for control of the transfer function of the optical element according to claim 1, that influences a spatially inhomogeneous, aperiodic, external electrical field over a part of a grating (3) along the direction of optical radiation propagation, with the aim of controlling the grating's diffraction efficiency.

13. Process for control of the transfer function of the optical element according to claim 12, characterised in that the influence of a spatially inhomogeneous, aperiodic, external electrical field over a part of the aforementioned grating (3) along the direction of optical radiation propagation has the aim of controlling the grating's maximum possible diffraction efficiency.

14. Process for controlling the transfer function of the optical element according to claim 12, characterised in that the direction of the vector of the electrical field strength on a part of the grating (3) is generated in the inverse direction of the vector of the electrical field strength on another part of the grating (3).
